(19) United States
(12) Patent Application Publication
(10) Pub. No.: US 2019/0139503 A1
(43) Pub. Date: May 9, 2019

(54) LIQUID CRYSTAL DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Meng CHEN, Shenzhen (CN)

(21) Appl. No.: 15/744,069

(22) PCT Filed: Dec. 14, 2017
(86) PCT No.: PCT/CN2017/116263

§ 371 Date: Jan. 12, 2018

(30) Foreign Application Priority Data
Nov. 6, 2017 (CN) 201711079399.7

(51) Int. Cl. G09G 3/36; G02F 1/1333; G02F 1/1343; G02F 1/1345; G02F 1/1339; G02F 1/1335

(52) U.S. Cl. CPC G09G 3/3614; G02F 1/133345; G02F 1/134309; G02F 1/1345; G09G 2330/021; G02F 1/133514; G02F 1/13439; G02F 2201/121; G02F 2201/123; G02F 1/13394

(57) ABSTRACT

The present invention provides a liquid crystal display device. The liquid crystal display device includes a common electrode that is arranged as a plurality of common electrode strips that are parallel with and spaced from each other and a metal connection line is arranged under each of the common electrode strips and connected to the common electrode strip and a signal input board. With the metal connection lines feeding alternating common voltages generated in the signal input board to the common electrode strips, during column reversing of the liquid crystal display device, the common voltage is constantly varied so as to achieve both column reversing of the liquid crystal display device and driving with alternating common voltages at the same time, and also help reduce power consumption of the liquid crystal display device.

### BACKGROUND OF THE INVENTION

### 1. Field of the Invention

The present invention relates to the field of display technology, and more particular to a liquid crystal display device.

### 2. The Related Arts

Liquid crystal display (LCD) has various advantages, such as thin device body, low power consumption, and being free of radiation, and has wide applications, such as liquid crystal televisions, mobile phones, personal digital assistants (PDAs), digital cameras, computer displays, and notebook computer screens, so as to take a leading position in the field of flat panel displays.

Most of the LCDs that are currently available in the market are backlighting LCDs, which comprise a liquid crystal display panel and a backlight module. The working principle of the liquid crystal display panel is that liquid crystal molecules are filled between a thin-film transistor (TFT) array substrate and a color filter (CF) substrate and a pixel voltage and a common voltage are respectively applied to the two substrates such that an electric field is induced between the pixel voltage and the common voltage to control a rotation direction of the liquid crystal molecules in order to refract out light emitting from the backlight module to generate an image.

The liquid crystal molecules have the characteristics that the liquid crystal molecules would get polarized if the liquid crystal molecules have been long applied with a voltage of the same polarity. Due to the characteristics being damaged, the liquid crystal molecules no long rotate with any variation of the electric field even after the voltage is removed. Thus, a liquid crystal panel must be driven in an alternate manner and the liquid crystal molecules must be reversed at a predetermined frequency when an image is displayed in order to prevent the liquid crystal molecules from losing their activity due to being constantly maintained at a fixed rotation direction. Heretofore, multiple reverse modes are available for liquid crystal display panels, such as point reverse mode, row reverse mode, and column reverse mode, where the means for realizing reversing is to keep switching positive and negative polarities of a source voltage of a thin-film transistor (TFT) (namely the positive and negative polarities of a pixel electrode), or alternatively, to keep switching positive and negative polarities of a common voltage, in order to achieve the purpose of alternate driving. When the voltage of the pixel electrode is higher than voltage of the common electrode, it is referred to as positive polarity pixel electrode. When the voltage of the pixel electrode is lower than voltage of the common electrode, it is referred to as negative polarity pixel electrode. Whether it is positive polarity or negative polarity, a fixed voltage difference between the pixel electrode and the common electrode would provide a fixed grey scale of displayeding.

For the liquid crystal display panels that are currently available, to suppress flickering, driving is often conducted with column reversing. Further, in the prior art techniques, the common electrode is often made in the form of a continuous flat structure that covers an entire display area, so that it is not possible to do driving with column reversing when alternate current is adopted for the common voltage (Vcom). Consequently, for the known liquid crystal display panels that are driven with column reversing, the common voltage (Vcom) can only use a direct-current voltage having a fixed voltage level and alternate driving can only be achieved by varying the pixel voltage. Under such a condition, with the presumption that for a specific gray scale, the positive polarity pixel voltage is Vp and the negative polarity pixel voltage is Vn, a voltage difference ΔV between the positive polarity pixel voltage and the common voltage Vcom is Vp-Vcom, and a voltage difference ΔV between the negative polarity pixel voltage and the common voltage Vcom is Vcom-Vn. When column reversing proceeds, a difference of 2ΔV is generated for conversion from the positive polarity pixel voltage to the negative polarity pixel voltage. This makes the difference between the positive polarity pixel voltage and the negative polarity pixel voltage very large during column reversing and the power consumption of the liquid crystal panel becomes high.

### SUMMARY OF THE INVENTION

An objective of the present invention is to provide a liquid crystal display panel that allow column reversing and common voltage alternate driving to be achievable for the liquid crystal display device, while the power consumption of the liquid crystal display device is reduced.

To achieve the above objective, the present invention provides a liquid crystal display device, which comprises: a liquid crystal display panel and a signal input board electrically connected to the liquid crystal display panel;

wherein the liquid crystal display panel comprises: a first substrate and a second substrate that are arranged opposite to each other;

the first substrate comprises: a first backing plate, a plurality of metal connection lines that are parallel to and spaced from each other and are arranged on one side of the first backing plate that is adjacent to the second substrate, a first insulation layer covering the metal connection lines and the first backing plate, and a plurality of common electrode strips that are parallel to and spaced from each other and are arranged on one side of the first insulation layer that is adjacent to the second substrate;

the first backing plate comprises a plurality of pixel areas arranged in an array, wherein each of the common electrode strips is arranged to correspond to one column of the pixel areas and each of the metal connection lines corresponds to and is electrically connected to one of the common electrode strips;

the signal input board is electrically connected to the plurality of metal connection lines to supply a common voltage, through each of the metal connection lines, to each of the common electrode strips; and

the common voltage is an alternating voltage comprising a first voltage level and a second voltage level alternating with each other, wherein the first voltage level is smaller than the second voltage level.

The first substrate and the second substrate comprise spacers arranged therebetween.

The first substrate further comprises: a color resist layer arranged between the first insulation layer and the common electrode layer.

The second substrate comprises: a second backing plate and a plurality of pixel electrodes, which are arranged in an array on the second insulation layer, wherein each of the pixel electrodes corresponds to one of the pixel areas.

For one frame of image, the common voltages of two adjacent ones of the common electrode strips are of opposite voltage levels, wherein the pixel electrodes of ones of pixel units that correspond to one of the common electrode strips that is applied with a common voltage having a first voltage level are provided with pixel voltages of positive polarity and the pixel electrodes of ones of the pixel units that correspond to one of the common electrode strips that is applied with a common voltage having a second voltage level are provided with pixel voltages of negative polarity; and

for two adjacent frames of image, common voltages of different voltage levels are applied to a same one of the common electrode strips.

The second substrate further comprises: a color resist layer arranged between the second backing plate and the pixel electrodes.

The metal connection lines are formed of a material comprising copper.

The common electrode strips are formed of a material comprising indium tin oxide (ITO) and the first insulation layer is formed of a material comprising one of silicon oxide and silicon nitride or a combination thereof.

The signal input board comprises: a plurality of signal output terminals, wherein each of the signal output terminals corresponds to and is electrically connected to one of the metal connection lines.

Each of the common electrode strips is electrically connected, through a via formed through the first insulation layer, to the metal connection lines.

The present invention also provides a liquid crystal display device, which comprises: a liquid crystal display panel and a signal input board electrically connected to the liquid crystal display panel;

wherein the liquid crystal display panel comprises: a first substrate and a second substrate that are arranged opposite to each other;

the first substrate comprises: a first backing plate, a plurality of metal connection lines that are parallel to and spaced from each other and are arranged on one side of the first backing plate that is adjacent to the second substrate, a first insulation layer covering the metal connection lines and the first backing plate, and a plurality of common electrode strips that are parallel to and spaced from each other and are arranged on one side of the first insulation layer that is adjacent to the second substrate;

the first backing plate comprises a plurality of pixel areas arranged in an array, wherein each of the common electrode strips is arranged to correspond to one column of the pixel areas and each of the metal connection lines corresponds to and is electrically connected to one of the common electrode strips;

the signal input board is electrically connected to the plurality of metal connection lines to supply a common voltage, through each of the metal connection lines, to each of the common electrode strips; and

the common voltage is an alternating voltage comprising a first voltage level and a second voltage level alternating with each other, wherein the first voltage level is smaller than the second voltage level;

wherein the first substrate and the second substrate comprise spacers arranged therebetween;

wherein the second substrate comprises: a second backing plate and a plurality of pixel electrodes, which are arranged in an array on the second insulation layer, wherein each of the pixel electrodes corresponds to one of the pixel areas;

wherein the common electrode strips are formed of a material comprising indium tin oxide (ITO) and the first insulation layer is formed of a material comprising one of silicon oxide and silicon nitride or a combination thereof; and

wherein the signal input board comprises: a plurality of signal output terminals, wherein each of the signal output terminals corresponds to and is electrically connected to one of the metal connection lines.

The efficacy of the present invention is as follows. The present invention provides a liquid crystal display device. The liquid crystal display device comprises a common electrode that is arranged as a plurality of common electrode strips that are parallel with and spaced from each other and a metal connection line is arranged under each of the common electrode strips and connected to the common electrode strip and a signal input board. With the metal connection lines feeding alternating common voltages generated in the signal input board to the common electrode strips, during column reversing of the liquid crystal display device, the common voltage is constantly varied so as to achieve both column reversing of the liquid crystal display device and driving with alternating common voltages at the same time, and also help reduce power consumption of the liquid crystal display device.

### BRIEF DESCRIPTION OF THE DRAWINGS

For better understanding of the features and technical contents of the present invention, reference will be made to the following detailed description of the present invention and the attached drawings. However, the drawings are provided only for reference and illustration and are not intended to limit the present invention.

In the drawings:

FIG. 1 is a schematic top plan view illustrating a first substrate and a signal input board of a liquid crystal display device according to the present invention;

FIG. 2 is a cross-sectional view illustrating a liquid crystal display panel of a first embodiment of the liquid crystal display device according to the present invention;

FIG. 3 is a cross-sectional view illustrating a liquid crystal display panel of a second embodiment of the liquid crystal display device according to the present invention; and

FIG. 4 is a schematic view illustrating an operation of the liquid crystal display device according to the present invention in a column reverse mode.

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

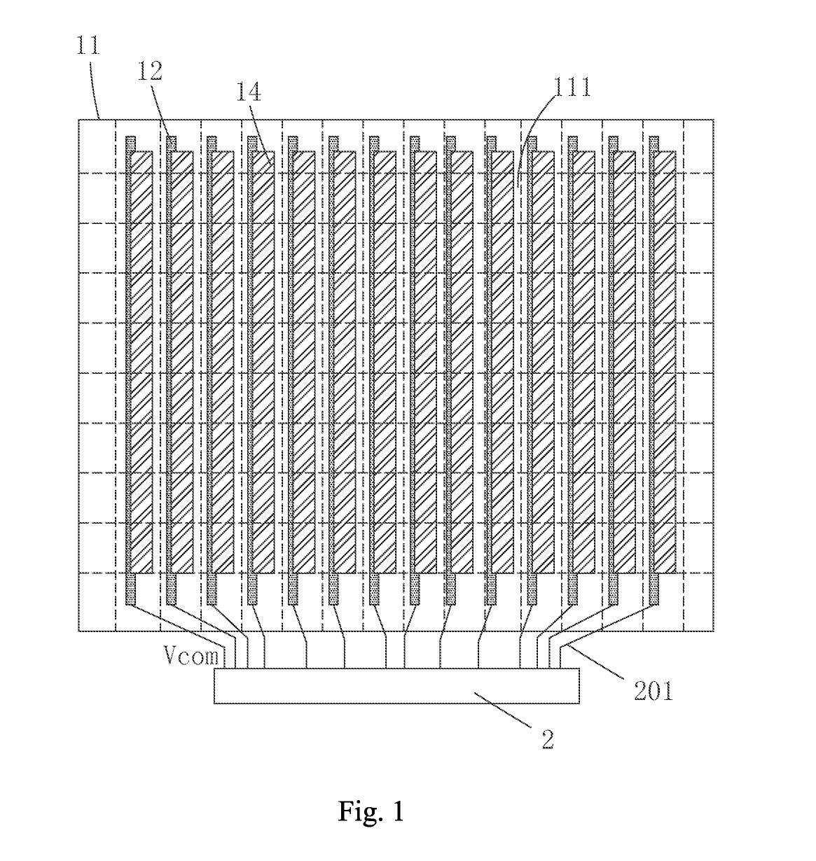

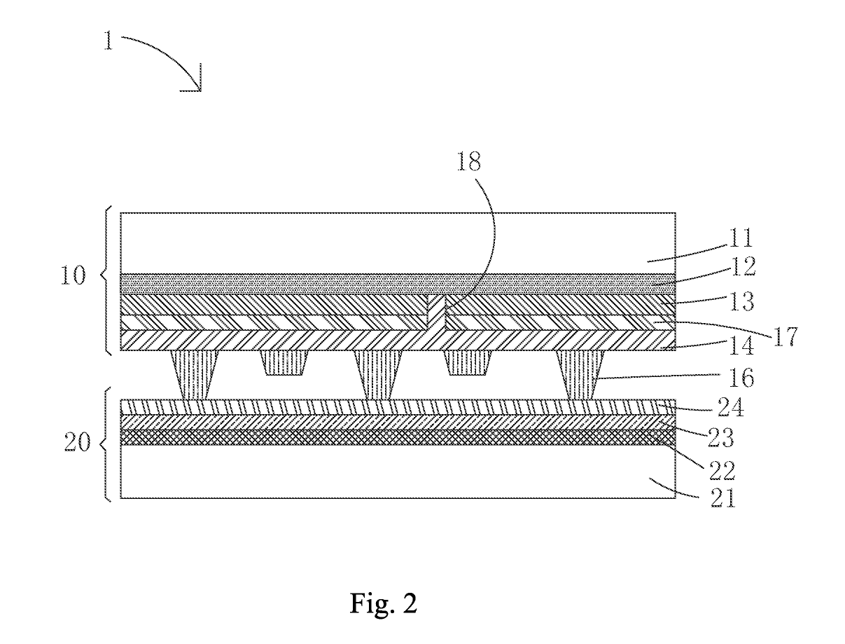

Referring to FIGS. 1 and 2, the present invention provides, in a first embodiment, a liquid crystal display device, which comprises: a liquid crystal display panel 1 and a signal input board 2 electrically connected to the liquid crystal display panel 1. The liquid crystal display panel 1 comprises: a first substrate 10 and a second substrate 20 that are arranged opposite to each other.

The first substrate 10 comprises: a first backing plate 11, a plurality of parallel and spaced metal connection lines 12 arranged on one side of the first backing plate 11 that is adjacent to the second substrate 20, a first insulation layer 13 covering the metal connection lines 12 and the first backing plate 11, a plurality of parallel and spaced common electrode strips 14 arranged on one side of the first insulation layer 13 that is adjacent to the second substrate 20, and a color resist layer 17 arranged between the first insulation layer 13 and the common electrode layer 14.

Further, the first backing plate 11 comprises a plurality of pixel areas 111 arranged in an array. Each of the common electrode strips 14 is arranged to correspond to one column of the pixel areas 111. Each of the metal connection lines 12 corresponds to and is electrically connected to one of the common electrode strips 14. The color resist layer 17 comprises a plurality of color resist blocks, and the plurality of color resist blocks respectively correspond to the plurality of pixel areas 111 in a one to one manner.

Specifically, the second substrate 20 comprises: a second backing plate 21, a thin-film transistor (TFT) layer 22 arranged on the second backing plate 21, a second insulation layer 23 arranged on the TFT layer 22, and a plurality of pixel electrodes 24, which are arranged in an array and are arranged on the second insulation layer 23 and electrically connected to the TFT layer 22. Each of the pixel electrodes 24 corresponds to one of the pixel areas 111.

Further, the TFT layer 22 comprises: a plurality of scan lines, a plurality of data lines, and a plurality of TFTs. Each of the TFTs corresponds to one of the pixel areas 111. Each of the scan lines corresponds to one row of the pixel areas 111. Each of the data lines corresponds to one column of the pixel areas 111. Each of the TFTs has a gate electrode electrically connected to the scan line corresponding thereto, a source electrode electrically connected to the data line corresponding thereto, and a drain electrode electrically connected to the pixel electrode 24 corresponding thereto.

Specifically, the first substrate 10 and the second substrate 20 are further provided with spacers 16 located therebetween.

Specifically, the signal input board 2 is electrically connected to the plurality of metal connection lines 12 to supply a common voltage Vcom, through each of the metal connection lines 12, to each of the common electrode strips 14. The common voltage Vcom comprises an alternating voltage that is switchable between a first voltage level Vcom1 and a second voltage level Vcom2.

Specifically, the signal input board 2 comprises: a plurality of signal output terminals 201, and each of the signal output terminals 201 corresponds to and is electrically connected to one of the metal connection lines 12.

It is noted that the metal connection lines 12 are formed of a material that comprises a metal having low resistivity, such as copper. Compared to an arrangement where the common electrode strips 14 are directly connected to the signal input board 2, using the metal connection lines 12 to connect the common electrode strips 14 and the signal input board 2 would reduce voltage delay caused by large electrical resistivity of the common electrode strips 14. Preferably, the common electrode strips 14 are formed of a material comprising indium tin oxide (ITO). The first insulation layer 13 is formed of a material comprising one of silicon oxide and silicon nitride, or a combination thereof.

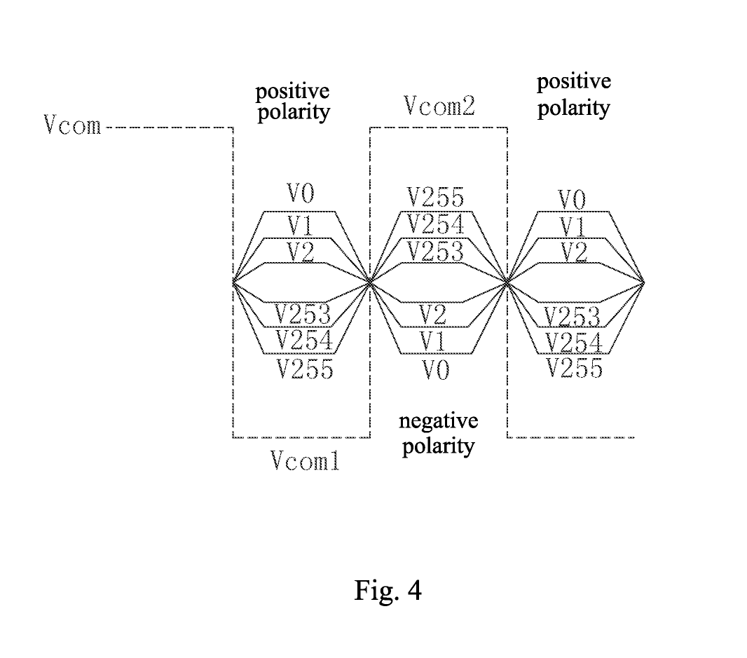

It is noted that, as shown in FIG. 4, a specific operation of the first embodiment of the present invention in column reversing is as follows. Firstly, the liquid crystal display panel displays a frame of image and the data lines supplies pixel voltages (V0-V255) to the pixel electrodes 24, wherein the pixel electrodes 24 of the same column have pixel voltages of the same polarity, while the pixel electrodes 24 of two adjacent columns have pixel voltages of opposite polarity. At the same time, the signal input board 2 supplies common voltages Vcom to the common electrode strips 14, wherein the common electrode strips 14 that correspond to the pixel electrodes 24 having a pixel voltage of positive polarity are provided with a common voltage Vcom of which a voltage level is the first voltage level Vcom1 and the common electrode strips 14 that correspond to the pixel electrodes 24 having a pixel voltage of positive polarity are provided with a common voltage Vcom of which a voltage level is the second voltage level Vcom2. Then, the liquid crystal display panel displays a next frame of image and proceeds with column reversing so that for the same one of pixel electrode 24, the polarity of the pixel voltage applied thereto is opposite to that of the previous frame, and at the same time, the common voltage Vcom of each of the common electrode strips 14 is also changed accordingly to ensure that the voltage level of the common voltage Vcom of the common electrode strips 14 that correspond to the pixel electrodes 24 that are applied with a pixel voltage of positive polarity is set at the first voltage level Vcom1, while the voltage level of the common voltage Vcom of the common electrode strips 14 that correspond to the pixel electrodes 24 that are applied with a pixel voltage of negative polarity is set at the second voltage level Vcom2. For the two frames of image, under the assumption that for a specific gray scale, the positive polarity pixel voltage is Vp and the negative polarity pixel voltage is Vn, then for the specific gray scale, a voltage difference between the positive polarity pixel voltage and the common voltage is ΔV, which is Vp−Vcom1, and a voltage difference the negative polarity pixel voltage and the common voltage is ΔV, which is Vcom2−Vn. During column reversing, for the specific gray scale, the positive polarity pixel voltage changing to the negative polarity pixel voltage results in a difference of 2ΔV−(Vcom2−Vcom1), meaning in driving with alternate common voltages, the difference between the positive polarity pixel voltage and the negative polarity pixel voltage is reduced by an amount of the difference related to the variation resulting from alternating the common voltage Vcom. Thus, the liquid crystal display device of the present invention allows the liquid crystal display device to operate with column reversing and also driving with alternating common voltages, and could reduce the voltage difference between the positive polarity pixel voltage and the negative polarity pixel voltage of the liquid crystal display device in the column reverse mode and also reduce power consumption of the liquid crystal display device.

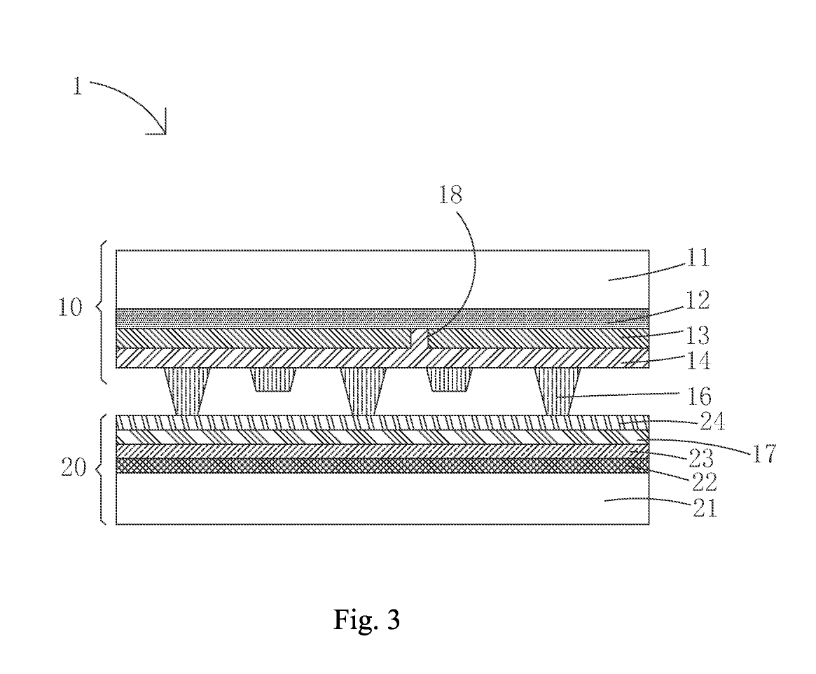

Referring to FIGS. 1 and 3, the present invention provides, in a second embodiment, a liquid crystal display device. The second embodiment is different from the first embodiment in that the second embodiment adopts the so-call color filter on array (COA) technology. In other words, in the second embodiment of the present invention, the color resist layer 17 is arranged on the second substrate 20. Specifically, the color resist layer 17 is located between the second insulation layer 23 and the pixel electrodes 24. The remaining is the same as that of the first embodiment and repeated description will be omitted herein.

It is noted that in the first embodiment of the present invention, each of the common electrode strips 14 is electrically connected through a via 18 formed through the first insulation layer 13 and the color resist layer 17 to the metal connection line 12. In the second embodiment of the present invention, each of the common electrode strips 14 is electrically connected through a via 18 formed through the first insulation layer 13 to the metal connection line 12.

In summary, the present invention provides a liquid crystal display device. The liquid crystal display device comprises a common electrode that is arranged as a plurality of common electrode strips that are parallel with and spaced from each other and a metal connection line is arranged under each of the common electrode strips and connected to the common electrode strip and a signal input board. With the metal connection lines feeding alternating common voltages generated in the signal input board to the common electrode strips, during column reversing of the liquid crystal display device, the common voltage is constantly varied so as to achieve both column reversing of the liquid crystal display device and driving with alternating common voltages at the same time, and also help reduce power consumption of the liquid crystal display device.

Based on the description given above, those having ordinary skills in the art may easily contemplate various changes and modifications of he technical solution and the technical ideas of the present invention. All these changes and modifications are considered belonging to the protection scope of the present invention as defined in the appended claims.

What is claimed is:

1. A liquid crystal display device, comprising: a liquid crystal display panel and a signal input board electrically connected to the liquid crystal display panel;
wherein the liquid crystal display panel comprises: a first substrate and a second substrate that are arranged opposite to each other;
the first substrate comprises: a first backing plate, a plurality of metal connection lines that are parallel to and spaced from each other and are arranged on one side of the first backing plate that is adjacent to the second substrate, a first insulation layer covering the metal connection lines and the first backing plate, and a plurality of common electrode strips that are parallel to and spaced from each other and are arranged on one side of the first insulation layer that is adjacent to the second substrate;
the first backing plate comprises a plurality of pixel areas arranged in an array, wherein each of the common electrode strips is arranged to correspond to one column of the pixel areas and each of the metal connection lines corresponds to and is electrically connected to one of the common electrode strips;
the signal input board is electrically connected to the plurality of metal connection lines to supply a common voltage, through each of the metal connection lines, to each of the common electrode strips; and
the common voltage is an alternating voltage comprising a first voltage level and a second voltage level alternating with each other, wherein the first voltage level is smaller than the second voltage level.

2. The liquid crystal display device according to claim 1, wherein the first substrate and the second substrate comprise spacers arranged therebetween.

3. The liquid crystal display device according to claim 1, wherein the first substrate further comprises: a color resist layer arranged between the first insulation layer and the common electrode layer.

4. The liquid crystal display device according to claim 1, wherein the second substrate comprises: a second backing plate and a plurality of pixel electrodes, which are arranged in an array on the second insulation layer, wherein each of the pixel electrodes corresponds to one of the pixel areas.

5. The liquid crystal display device according to claim 4, wherein for one frame of image, the common voltages of two adjacent ones of the common electrode strips are of opposite voltage levels, wherein the pixel electrodes of ones of pixel units that correspond to one of the common electrode strips that is applied with a common voltage having a first voltage level are provided with pixel voltages of positive polarity and the pixel electrodes of ones of the pixel units that correspond to one of the common electrode strips that is applied with a common voltage having a second voltage level are provided with pixel voltages of negative polarity; and
for two adjacent frames of image, common voltages of different voltage levels are applied to a same one of the common electrode strips.

6. The liquid crystal display device according to claim 4, wherein the second substrate further comprises: a color resist layer arranged between the second backing plate and the pixel electrodes

7. The liquid crystal display device according to claim 1, wherein the metal connection lines are formed of a material comprising copper.

8. The liquid crystal display device according to claim 1, wherein the common electrode strips are formed of a material comprising indium tin oxide (ITO) and the first insulation layer is formed of a material comprising one of silicon oxide and silicon nitride or a combination thereof.

9. The liquid crystal display device according to claim 1, wherein the signal input board comprises: a plurality of signal output terminals, wherein each of the signal output terminals corresponds to and is electrically connected to one of the metal connection lines.

10. The liquid crystal display device according to claim 1, wherein each of the common electrode strips is electrically connected, through a via formed through the first insulation layer, to the metal connection lines.

11. A liquid crystal display device, comprising: a liquid crystal display panel and a signal input board electrically connected to the liquid crystal display panel;
wherein the liquid crystal display panel comprises: a first substrate and a second substrate that are arranged opposite to each other;
the first substrate comprises: a first backing plate, a plurality of metal connection lines that are parallel to and spaced from each other and are arranged on one side of the first backing plate that is adjacent to the second substrate, a first insulation layer covering the metal connection lines and the first backing plate, and a plurality of common electrode strips that are parallel to and spaced from each other and are arranged on one side of the first insulation layer that is adjacent to the second substrate;
the first backing plate comprises a plurality of pixel areas arranged in an array, wherein each of the common electrode strips is arranged to correspond to one column of the pixel areas and each of the metal connection lines corresponds to and is electrically connected to one of the common electrode strips;
the signal input board is electrically connected to the plurality of metal connection lines to supply a common voltage, through each of the metal connection lines, to each of the common electrode strips; and
the common voltage is an alternating voltage comprising a first voltage level and a second voltage level alternating with each other, wherein the first voltage level is smaller than the second voltage level;
wherein the first substrate and the second substrate comprise spacers arranged therebetween;
wherein the second substrate comprises: a second backing plate and a plurality of pixel electrodes, which are arranged in an array on the second insulation layer, wherein each of the pixel electrodes corresponds to one of the pixel areas;
wherein the common electrode strips are formed of a material comprising indium tin oxide (ITO) and the first insulation layer is formed of a material comprising one of silicon oxide and silicon nitride or a combination thereof; and
wherein the signal input board comprises: a plurality of signal output terminals, wherein each of the signal output terminals corresponds to and is electrically connected to one of the metal connection lines.

12. The liquid crystal display device according to claim 11, wherein the first substrate further comprises: a color resist layer arranged between the first insulation layer and the common electrode layer.

13. The liquid crystal display device according to claim 11, wherein for one frame of image, the common voltages of two adjacent ones of the common electrode strips are of opposite voltage levels, wherein the pixel electrodes of ones of pixel units that correspond to one of the common electrode strips that is applied with a common voltage having a first voltage level are provided with pixel voltages of positive polarity and the pixel electrodes of ones of the pixel units that correspond to one of the common electrode strips that is applied with a common voltage having a second voltage level are provided with pixel voltages of negative polarity; and
for two adjacent frames of image, common voltages of different voltage levels are applied to a same one of the common electrode strips.

14. The liquid crystal display device according to claim 11, wherein the second substrate further comprises: a color resist layer arranged between the second backing plate and the pixel electrodes.

15. The liquid crystal display device according to claim 11, wherein the metal connection lines are formed of a material comprising copper.

16. The liquid crystal display device according to claim 11, wherein each of the common electrode strips is electrically connected, through a via formed through the first insulation layer, to the metal connection lines.
